(19) United States
(12) Patent Application Publication
(10) Pub. No.: US 2009/0135367 A1
(43) Pub. Date: May 28, 2009

(54) LIQUID CRYSTAL DISPLAY DEVICE AND LIQUID CRYSTAL MIXTURE USED BY THE SAME

(75) Inventors: Byeong-seob BAN, Seongnam-si (KR); Sung-tae SHIN, Seongnam-si (KR); Hee-seop KIM, Hwaseong-si (KR); Hyun-ku AHN, Hwanseong-si (KR)

Correspondence Address: H.C. PARK & ASSOCIATES, PLC, 8500 LEESBURG PIKE, SUITE 7500, VIENNA, VA, 22182, US

(73) Assignee: SAMSUNG ELECTRONICS CO., LTD., Suwon-si (KR)

(21) Appl. No.: 12/203,387

(22) Filed: Sep. 3, 2008

(30) Foreign Application Priority Data
Nov. 28, 2007 (KR) 10-2007-0122105

(51) Int. Cl. G02F 1/13; C09K 19/00

(52) U.S. Cl. 349/182

(57) ABSTRACT

A liquid crystal display includes a first display panel including a pixel electrode, a second display panel spaced apart from and facing the first display panel, and a liquid crystal mixture disposed between the first and second display panels. The liquid crystal mixture contains liquid crystals represented by Formula (1):

D-C-A-C′-D′ (1).

A is a phenyl, biphenyl, terphenyl or naphthalene compound, C and C′ are each —COO—, —OOC—, —CF₂O—, or —OF₂C—, and D and D′ are each independently a compound represented by Formula (2) or a compound represented by Formula (3):

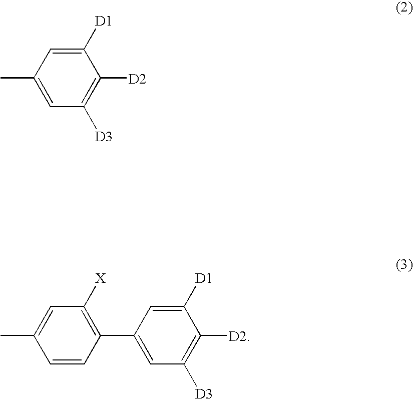

### CROSS-REFERENCE TO RELATED APPLICATION

This application claims priority from and the benefit of Korean Patent Application No. 10-2007-0122105, filed on Nov. 28, 2007, which is hereby incorporated by reference for all purposes as if fully set forth herein.

### BACKGROUND OF THE INVENTION

1. Field of the Invention

The present invention relates to a liquid crystal mixture and a liquid crystal display including the same, and, more particularly, to a liquid crystal mixture that may provide for a high response speed and superior visibility, and a liquid crystal display including the same.

2. Discussion of the Background

Liquid crystal display devices are widely used flat panel displays. A liquid crystal display device includes two panels provided with field-generating electrodes, such as pixel electrodes and a common electrode, and a liquid crystal mixture interposed therebetween. The liquid crystal display device displays an image when a voltage is applied to the field-generating electrodes to generate an electric field in the liquid crystal mixture, which alters the alignment of liquid crystal molecules in the liquid crystal mixture to adjust the polarization of incident light.

In recent years, increasing the response speed and increasing the viewing angle have become important issues in liquid crystal devices. To meet these requirements, biaxial liquid crystal materials having three or more refraction indices are being researched.

Liquid crystals may be in one of a nematic phase, a smectic phase, and a cholesteric phase. Particularly, in order to improve the response speed and viewing angle of liquid crystals, nematic phase liquid crystal compositions, which are superior in the alignment and yield of liquid crystals, are being researched.

However, while biaxial liquid crystals exhibit a nematic phase at high temperatures, they do not exhibit a nematic phase at room temperature. Therefore, a liquid crystal display including biaxial liquid crystals may render residual images.

Accordingly, there is a need for a liquid crystal display that includes biaxial liquid crystals that exhibit a nematic phase at room temperature without rendering residual images and that has a high response speed and a wide viewing angle.

### SUMMARY OF THE INVENTION

The present invention provides a liquid crystal display that may have a high response speed and superior visibility.

The present invention also provides a liquid crystal mixture including nematic phase liquid crystals at room temperature.

Additional features of the invention will be set forth in the description which follows, and in part will be apparent from the description, or may be learned by practice of the invention.

The present invention discloses a liquid crystal display including a first display panel including a pixel electrode, a second display panel spaced apart from and facing the first display panel, and a liquid crystal mixture disposed between the first and second display panels. The liquid crystal mixture contains liquid crystals represented by Formula (1):

D-C-A-C′-D′ (1)

A is a phenyl, biphenyl, terphenyl, or naphthalene compound, C and C′ are each independently at least one of —COO—, —OOC—, —CF₂O—, and —OF₂C—, and D and D′ are each independently at least one of a compound represented by Formula (2) and a compound represented by Formula (3):

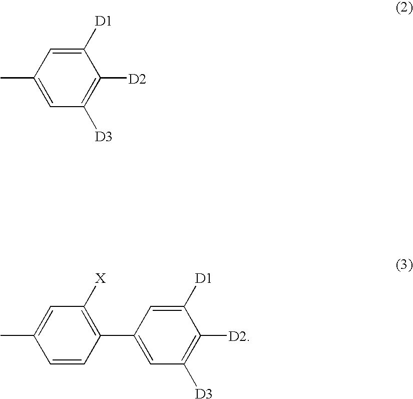

D1 and D3 are each independently at least one of H, F and C1, D2 is at least one of H, F, Cl, —OCF₃, an alkyl group having no more than 5 carbons, an alkoxy group having no more than 5 carbons, and an alkenyl group having no more than 5 carbons, and X is at least of H, F, and Cl.

The present invention also discloses a liquid crystal display including a first display panel including a pixel electrode, a second display panel spaced apart from and facing the first display panel, and a liquid crystal mixture disposed between the first and second display panels. The liquid crystal mixture contains liquid crystals represented by Formula (4):

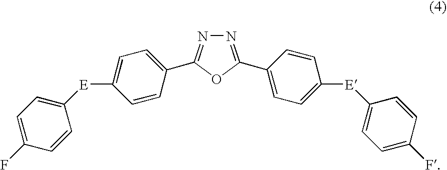

E and E′ are each independently at least one of —CF₂O— and —OF₂C—, and F and F′ are each independently at least one selected of an alkyl group, an alkoxy group, and an alkenyl group.

The present invention also discloses a liquid crystal display including a first display panel including a pixel electrode, a second display panel spaced apart from and facing the first display panel, and a liquid crystal mixture disposed between the first and second display panels. The liquid crystal mixture contains liquid crystals represented by Formula (5):

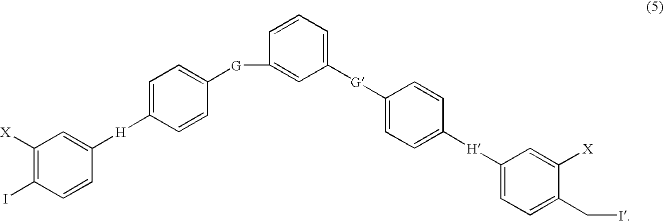

G, G′, H, and H′ are each independently at least one of —CF₂O— and —OF₂C—, X is at least one of H, F, Cl, an alkyl group, and an alkoxy group, and I and I′ are each independently at least one of an alkyl group, an alkoxy group, and an alkenyl group.

The present invention also discloses a liquid crystal display including a first display panel including a pixel electrode, a second display panel spaced apart from and facing the first display panel, and a liquid crystal mixture disposed between the first and second display panels. The liquid crystal mixture contains liquid crystals represented by Formula (6):

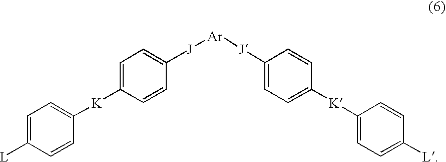

J, J′, K, and K′ are each independently at least one of —CF₂O— and —OF₂C—, Ar is an aromatic ring, and L and L′ are each independently at least one of an alkyl group, an alkoxy group, and an alkenyl group.

The present invention also discloses a liquid crystal mixture containing liquid crystals represented by Formula (1):

D-C-A-C′-D′ (1)

A is a phenyl, biphenyl, terphenyl, or naphthalene compound, C and C′ are each independently at least one of —COO—, —OOC—, —CF₂O—, and —OF₂C—, and D and D′ are each independently at least one of a compound represented by Formula (2) and a compound represented by Formula (3):

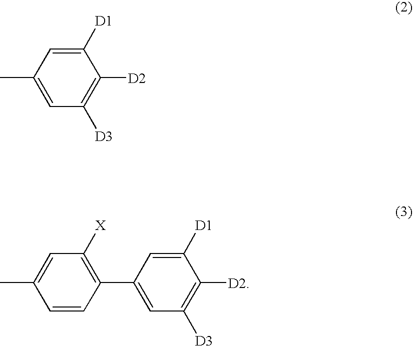

D1 and D3 are each independently at least one of H, F and Cl, D2 is at least one of H, F, Cl, —OCF₃, an alkyl group having no more than 5 carbons, an alkoxy group having no more than 5 carbons, and an alkenyl group having no more than 5 carbons, and X is at least one of H, F, and Cl.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a cross-sectional view of a liquid crystal display according to an exemplary embodiment of the present invention.

FIG. 2 is a view schematically showing a nematic liquid crystal mixture according to an exemplary embodiment of the present invention.

FIG. 3 is a view schematically showing a biaxial liquid crystal mixture according to an exemplary embodiment of the present invention.

### DETAILED DESCRIPTION OF THE ILLUSTRATED EMBODIMENTS

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. In the drawings, the size and relative sizes of layers and regions may be exaggerated for clarity. Like reference numerals in the drawings denote like elements.

It should also be understood that when a layer is referred to as being “on” another layer or substrate, it can be directly on the other layer or substrate, or intervening layers may also be present. In contrast, when an element is referred to as being “directly on” another element, there are no intervening elements present. It will also be understood that the term “and/or” as used herein refers to and encompasses any and all possible combinations of one or more of the associated listed items.

Spatially relative terms, such as “below,” “beneath,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures.

Exemplary embodiments of the present invention are described herein with reference to cross-section illustrations that are schematic illustrations of idealized embodiments (and intermediate structures) of the present invention. As such, variations from the shapes of the illustrations as a result, for example, of manufacturing techniques and/or tolerances, are to be expected. Thus, exemplary embodiments of the present invention should not be construed as limited to the particular shapes of regions illustrated herein but are to include deviations in shapes that result, for example, from manufacturing.

Hereinafter, an LCD device according to an exemplary embodiment of the present invention will be explained in more detail with reference to the accompanying drawings.

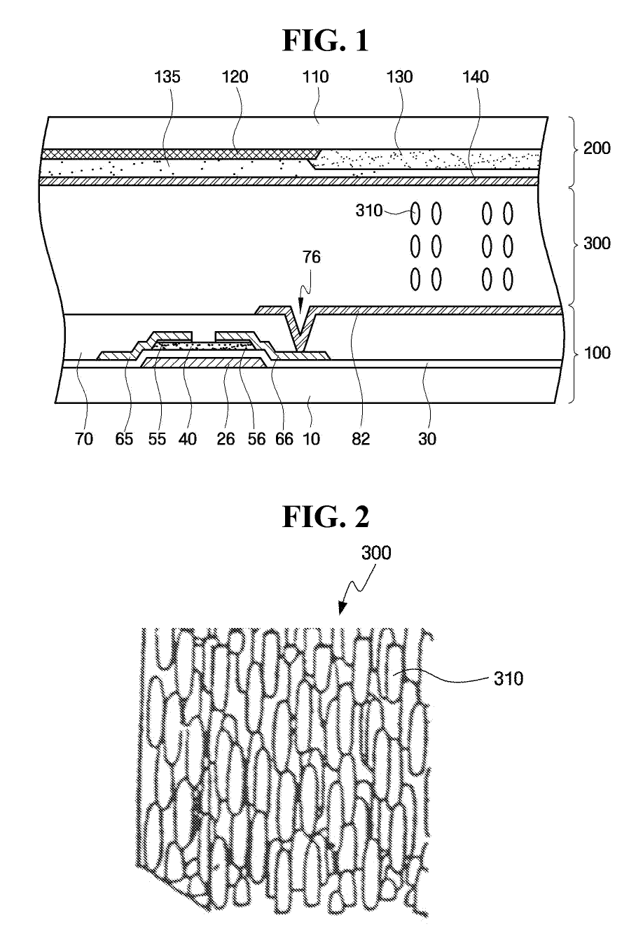

FIG. 1 is a cross-sectional view of a liquid crystal display according to an exemplary embodiment of the present invention.

Referring to FIG. 1, the liquid crystal display according to the present exemplary embodiment of the invention includes a first display panel 100, a second display panel 200 facing the first display panel 100, and a liquid crystal mixture 300 disposed between the first display panel 100 and the second display panel 200.

The first display panel 100 includes a plurality of elements, including a pixel electrode 82 disposed on a first insulating substrate 10.

A gate wire, including gate lines (not shown), a gate electrode 26, and a storage wire (not shown), is disposed on the first insulating substrate 10 in a horizontal direction.

A gate-insulating layer 30, which may be made of SiNₓ or SiOₓ, is disposed on top of the gate wire. A semiconductor layer 40, which may be made of hydrogenated amorphous silicon or polysilicon, is disposed on the gate-insulating layer 30. An ohmic contact layer 55, 56, which may be made of silicide or n+ hydrogenated amorphous silicon heavily doped with n-type impurities, is disposed on the semiconductor layer 40.

A data wire, including data lines (not shown) disposed on the first insulating substrate 10 in a longitudinal direction, a source electrode 65, and a drain electrode 66, is disposed on the ohmic contact layer 55, 56 and the gate-insulating layer 30.

The passivation layer 70, which may be an insulating layer, is disposed on the data line, the drain electrode 66, and portions of the semiconductor layer 40 that are not covered with the data wire. The passivation layer 70 is provided with a contact hole 76 exposing the drain electrode 66. A pixel electrode 82 is disposed on the passivation layer 70 and connected to the drain electrode 66 in each pixel area via the corresponding contact hole 76 in the passivation layer 70. That is, the pixel electrode 82 is directly connected to the drain electrode 66 via the contact hole 76 and receives a data voltage from the drain electrode 66. The pixel electrode 82 may be made of a transparent conductor such as Indium Tin Oxide (ITO) or Indium Zinc Oxide (IZO), or a reflective conductor, such as aluminum (Al).

The second display panel 200 of the liquid crystal display according to the present exemplary embodiment of the invention includes a second insulating substrate 110 and faces the first display panel 100.

Black matrixes 120 are provided on the second insulating substrate 110 to prevent light leakage and to define pixel areas.

A plurality of red, green, and blue color filters 130 are sequentially arranged on the pixel areas between adjacent black matrixes 120. An overcoat layer 135 may be formed on the color filters 130 and black matrixes 120 to provide a flat surface. A common electrode 140, which may be made of a transparent conductive material, such as ITO, IZO, etc., may be disposed on the overcoat layer 135.

For convenience of explanation, the liquid crystal display having the color filters 130 and the common electrode 140 disposed on the second insulating substrate 110 has been described in exemplary embodiments, but the invention is not limited thereto and can also be advantageously applied to an Array On Color filter (AOC) liquid crystal display having a color filter disposed on a first insulating substrate and a thin film transistor array including a gate wire, and others, disposed thereon, or a Color filter On Array (COA) liquid crystal display having a color filter disposed on a thin film transistor array. In addition, various modified exemplary embodiments, in which a common electrode 140 is disposed on a first insulating substrate 10, are possible.

The liquid crystal display according to the present exemplary embodiment of the present invention may employ one of various driving modes, including a twisted nematic (TN) mode, an in plane switching (IPS) mode, a fringe field switching (FFS) mode, and a Vertical Alignment (VA) mode.

The liquid crystal mixture 300 including liquid crystals 310 is interposed between the first display panel 100 and the second display panel 200 that face each other.

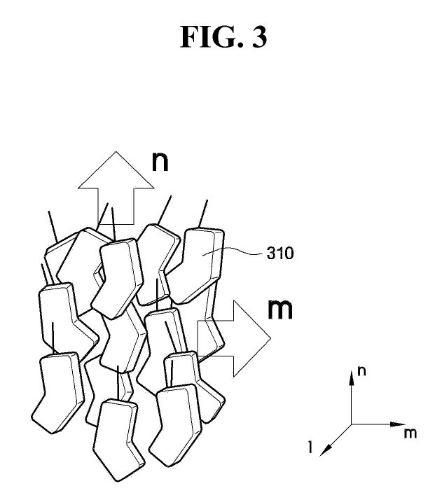

Hereinafter, liquid crystals 310 according to the present exemplary embodiment of the invention will be described in detail with reference to FIG. 1, FIG. 2, and FIG. 3. FIG. 2 is a view schematically showing a nematic liquid crystal mixture according to an exemplary embodiment of the present invention, and FIG. 3 is a view schematically showing a biaxial liquid crystal mixture according to an exemplary embodiment of the present invention.

Referring to FIG. 1 and FIG. 2, the liquid crystals 310 contained in the liquid crystal mixture 300 may be, for example, nematic liquid crystals.

The nematic liquid crystals may include liquid crystal molecules aligned in one direction, and the centers of gravity of the liquid crystal molecules are arranged in a disordered fashion, as shown in FIG. 2.

Compared to smectic liquid crystals or cholesteric liquid crystals, the nematic liquid crystals may provide easy alignment and an improved yield of liquid crystal molecules.

Referring to FIG. 1 and FIG. 3, the liquid crystals 310 of this exemplary embodiment may be biaxial liquid crystals. That is, the liquid crystals 310 may be biaxial nematic liquid crystals (BNLC).

In general, a uniaxial liquid crystal (not shown) may have a rod-like shape or a disc shape. The rod-like liquid crystal has an axis in the lengthwise direction of the rod and the disc-shaped liquid crystal has an axis in a direction perpendicular to the disc plane. In contrast, the biaxial liquid crystals 310 of this exemplary embodiment may have bent-core molecular structures or cross structures, as shown in FIG. 3. A bent-core liquid crystal 310 has a boomerang shape in which the liquid crystal 310 is arranged into a bent pattern of a boomerang shape in opposite directions in view of the core. That is, there are two axes in directions of the length and plane of the boomerang, i.e., the axes n and m.

The biaxial liquid crystals 310 have different refractive indices in the three axial directions: n, m, and l. Accordingly, the liquid crystal display including the liquid crystals 310 may have a reduced difference in display quality according to the direction in which the liquid crystal display is viewed, thereby achieving a wide viewing angle. In addition, since the biaxial liquid crystals 310 have two axes in the lengthwise and planar directions, i.e., in the n and m axes, the response speed, which is determined by the voltage applied to the liquid crystal display, may be increased. Further, the visibility may be improved by the multi-domain effect of the biaxial liquid crystals 310.

Hereinafter, structures of the liquid crystals 310 according to an exemplary embodiment of the present invention will be described in detail.

The liquid crystals 310 of the current exemplary embodiment of the present invention are represented by Formula (1) and have a biaxial nematic phase at room temperature:

D-C-A-C′-D′ (1)

A, which is the core portion, may be a phenyl, biphenyl, terphenyl, or naphthalene compound. Exemplary compounds of A include:

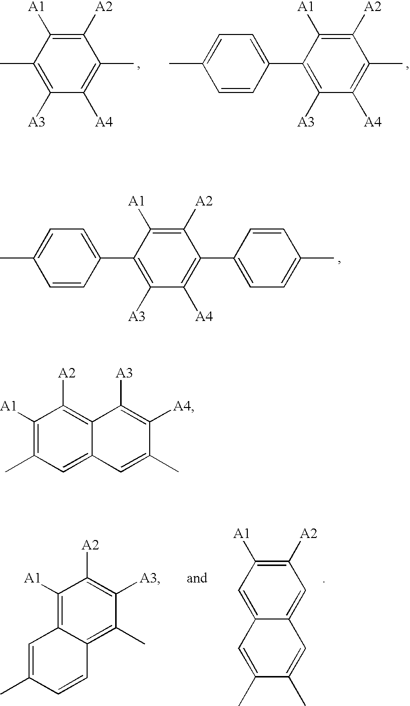

The compound represented by Formula (1) may have a bent-core molecular structure or a cross structure according to the type of A compound used. For example, when A is

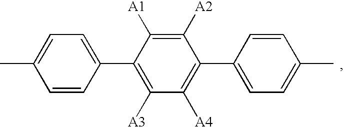

the compound represented by Formula (1) has a cross structure. Among the compounds stated above, A1, A2, A3, and A4 may each independently be at least one of H, F, and Cl.

C and C′ may each independently be at least one of —COO—, —OOC—, —CF₂O—, and —OF₂C—. For example, C and C′ may each independently be —CF₂O— and —OF₂C—.

B may further be included between C and A, or B′ may further be included between A and C′, in the liquid crystal mixture represented by Formula (1). That is, in the liquid crystals 310 according to an exemplary embodiment of the present invention, A and C may be directly coupled to each other, and A and C′ may be directly coupled to each other, as represented by Formula (1). Alternatively, B and B′ may be interposed between A and C and between A and C′, respectively.

In this case, the above Formula (1) may be transformed into a structure represented by one of D-C-B-A-C′-D′, D-C-A-B′-C′-D′, and D-C-B-A-B′-C′-D′, wherein B and B′ are each independently at least one of phenyl, phenyl-cyclohexane, and cyclohexane-phenyl.

D and D′ are each independently at least one of a compound represented by Formula (2) and a compound represented by Formula (3):

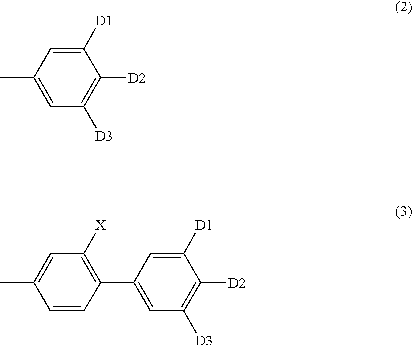

D1 and D3 are each independently at least one of H, F, and Cl, D2 is at least one of H, F, Cl, —OCF₃, and at least one of an alkyl group having 5 or less carbons, an alkoxy group having 5 or less carbons, and an alkenyl group having 5 or less carbons, and X is at least one of H, F, and Cl.

In particular, D2 may be at least one of an alkyl group having 5 or less carbons, an alkoxy group having 5 or less carbons, and an alkenyl group having 5 or less carbons. If the number of carbon atoms is less than 5, the nematic phase may occur at low temperatures. As described above, since the liquid crystals 310 according to an exemplary embodiment of the present invention have a bent-core molecular structure or a cross structure, they may have a high response speed. In addition, a wide viewing angle may be obtained by forming multiple domains in the liquid crystals 310. Here, the term “domain” means a region where liquid crystals 310 are tilted in by the electric field formed between the pixel electrode 82 and the common electrode 140.

Hereinafter, liquid crystals 310 according to another exemplary embodiment of the present invention will be described in detail. Liquid crystal displays employing liquid crystals 310 according to the following exemplary embodiments are the same as the liquid crystal display according to the previous exemplary embodiment and a detailed explanation thereof will not be given or a brief description will be given.

The liquid crystal display according to the present exemplary embodiment includes a liquid crystal mixture 300 disposed between first and second display panels 100 and 200 and containing liquid crystals 310 represented by Formula (4):

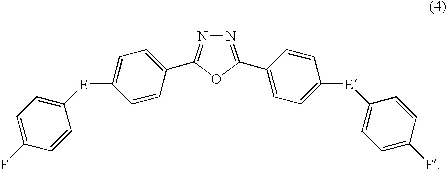

E and E′ are each independently at least one of —CF₂O— and —OF₂C—. Thus, it may be possible to reduce the occurrence of residual images in the liquid crystal display as compared to the case when E and E′ are each independently an ester group.

In Formula (4), F and F′ may each independently be at least one of an alkyl group, an alkoxy group, and an alkenyl group. Specifically, F and F′ may be an alkyl group having 5 or less carbons, an alkoxy group having 5 or less carbons, or an alkenyl group having 5 or less carbons.

As described above, if the compound represented by Formula (4) has a terminal group having a small number of carbon atoms, the liquid crystals 310 have a biaxial nematic phase at room temperature. That is, if the terminal group is a C7 alkyl group, the compound represented by Formula (4) exhibits a nematic phase at a temperature in the range of 173° C. to 222° C., and may exhibit a smectic phase at a temperature below this range. However, if the compound represented by Formula (4) has a terminal group having a small number of carbon atoms, a phase transition temperature may be lowered, so that the compound represented by Formula (4) may have a nematic phase at room temperature.

Hereinafter, liquid crystals 310 according to still another exemplary embodiment of the present invention will be described in detail.

The liquid crystal display according to the present exemplary embodiment includes a liquid crystal mixture disposed between first and second display panels 100 and 200 and containing liquid crystals 310 represented by Formula (5):

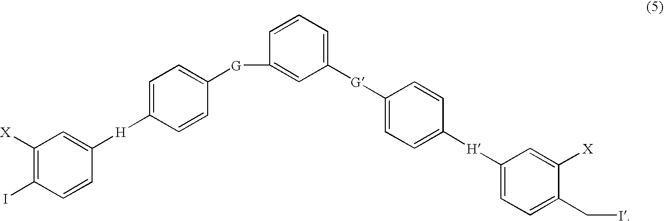

G, G′, H, and H′ are each independently at least one of —CF₂O— and —OF₂C—. It may be possible to reduce the occurrence of residual images in the liquid crystal display as compared to the case when G, G′, H, and H′ are each independently an ester group or —CH═N—, which may improve the reliability of the liquid crystal display.

X is at least one of H, F, Cl, an alkyl group, and an alkoxy group. Particularly, the alkyl group or alkoxy group may be at least one of CH₃, OCH₃, and OC₂H₅.

I and I′ are each independently at least one of an alkyl group, an alkoxy group, and an alkenyl group. In each of the alkyl group, the alkoxy group, and the alkenyl group, the number of carbon atoms may be 5 or less.

If the number of carbon atoms of the terminal group is greater than 5, the liquid crystals 310 of the present exemplary embodiment may not have a smectic phase over all temperature ranges. However, the liquid crystals 310 of the present exemplary embodiment may be in a biaxial nematic phase at room temperature when the number of carbon atoms of the terminal group does not exceed 5.

Hereinafter, liquid crystals 310 according to still another exemplary embodiment of the present invention will be described in detail.

The liquid crystal display according to the present exemplary embodiment includes a liquid crystal mixture 300 disposed between first and second display panels 100 and 200 and containing liquid crystals 310 represented by Formula (6):

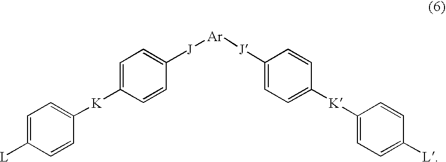

J, J′, K, and K′ are each independently at least one of —CF₂O— and —OF₂C—. Thus, it may be possible to prevent a residual image from occurring to the liquid crystal display when J, J′, K, and K′ are each independently an ester group, which may improve the reliability of the liquid crystal display.

Ar is an aromatic ring, specifically at least one of

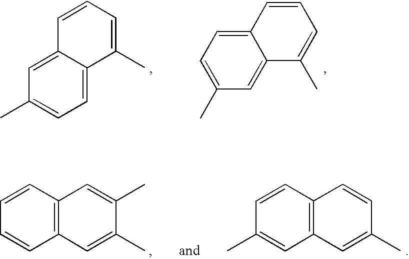

L and L′ are each independently at least one of an alkyl group, an alkoxy group, and an alkenyl group. In each of the alkyl group, the alkoxy group, and the alkenyl group, the number of carbon atoms should not be greater than 10 and for example, may be 5 or less. If the number of carbon atoms of the terminal group is greater than 10, a smectic phase may predominantly occur in the liquid crystals 310 over a wide temperature range, and a nematic phase may occur at a temperature higher than 200° C. The liquid crystals 310 of the present exemplary embodiment may be made to be in a biaxial nematic phase at room temperature by reducing the number of carbon atoms of the terminal group.

As described above, according to the exemplary embodiments of the present invention, a liquid crystal display having a high response speed may be manufactured using a liquid crystal mixture containing biaxial liquid crystals. In addition, the liquid crystal display having a wide viewing angle may be manufactured using a liquid crystal mixture containing biaxial liquid crystals. Further, a liquid crystal display that may have improved reliability can be manufactured using liquid crystals exhibiting a nematic phase at room temperature.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display, comprising:
a first display panel comprising a pixel electrode;
a second display panel spaced apart from and facing the first display panel; and
a liquid crystal mixture disposed between the first display panel and the second display panel and comprising liquid crystals represented by Formula (1):
D-C-A-C′-D′ (1)
wherein A is a phenyl compound, a biphenyl compound, a terphenyl compound, or a naphthalene compound; C and C′ are each independently at least one of —COO—, —OOC—, —CF₂O—, and —OF₂C—; D and D′ are each independently at least one of a compound represented by Formula (2) and a compound represented by Formula (3): 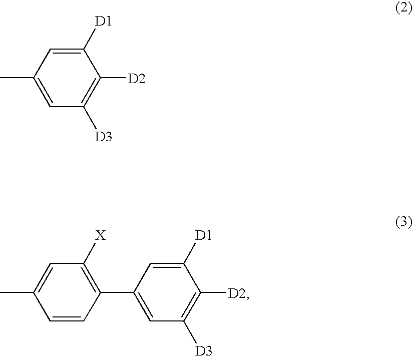
wherein D1 and D3 are each independently at least one of H, F, and Cl; D2 is at least one of H, F, Cl, —OCF₃, an alkyl group having 5 or less carbons, an alkoxy group having 5 or less carbons, and an alkenyl group having 5 or less carbons; and X is at least one of H, F, and Cl.

2. The liquid crystal display of claim 1, wherein in the liquid crystal mixture represented by Formula (1), A is at least one of. 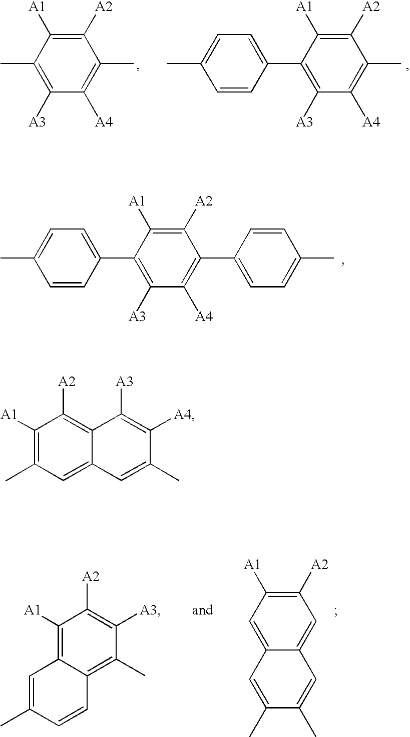
wherein A1, A2, A3, and A4 are each independently at least one of H, F, and Cl.

3. The liquid crystal display of claim 1, wherein C and C′ are each independently at least one of —CF₂O— and —OF₂C—.

4. The liquid crystal display of claim 1, wherein B is further included between C and A, or B′ is further included between A and C′, in the liquid crystal mixture represented by Formula (1).

5. The liquid crystal display of claim 4, wherein B and B′ are each independently at least one of phenyl, phenyl-cyclohexane, and cyclohexane-phenyl.

6. A liquid crystal display, comprising:
a first display panel comprising a pixel electrode;
a second display panel spaced apart from and facing the first display panel; and
a liquid crystal mixture disposed between the first display panel and the second display panel and comprising liquid crystals represented by Formula (4): 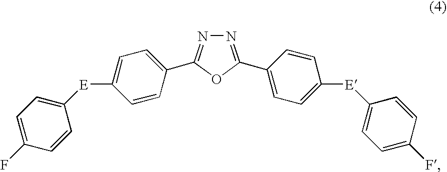
wherein E and E′ are each independently at least one of —CF₂O— and —OF₂C—; and F and F′ are each independently at least one of an alkyl group, an alkoxy group, and an alkenyl group.

7. The liquid crystal display of claim 6, wherein in each of the alkyl group, the alkoxy group, and the alkenyl groups of F and F′, the number of carbon atoms is not greater than 5.

8. A liquid crystal display, comprising:
a first display panel comprising a pixel electrode;
a second display panel spaced apart from and facing the first display panel; and
a liquid crystal mixture disposed between the first display panel and the second display panel and comprising liquid crystals represented by Formula (5): 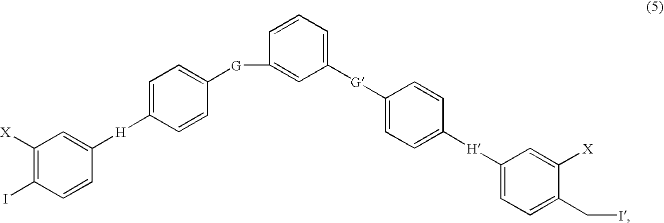
wherein G, G′, H, and H′ are each independently at least one of —CF₂O— and —OF₂C—; X is at least one of H, F, Cl, an alkyl group, and an alkoxy group; and I and I′ are each independently at least one of an alkyl group, an alkoxy group, and an alkenyl group.

9. The liquid crystal display of claim 8, wherein in each of the alkyl group, the alkoxy group, and the alkenyl groups of I and I′, the number of carbon atoms is not greater than 5.

10. The liquid crystal display of claim 8, wherein the alkyl group or the alkoxy group of X is at least one of CH₃, OCH₃, and OC₂H₅.

11. A liquid crystal display, comprising:
a first display panel comprising a pixel electrode;
a second display panel spaced apart from and facing the first display panel; and
a liquid crystal mixture disposed between the first display panel and the second display panel and comprising liquid crystals represented by Formula (6): 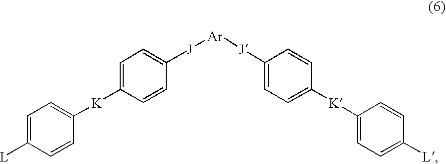
wherein J, J′, K, and K′ are each independently at least one of —CF₂O— and —OF2C—; Ar is an aromatic ring; and L and L′ are each independently at least one of an alkyl group, an alkoxy group, and an alkenyl group.

12. The liquid crystal display of claim 11, wherein in each of the alkyl group, the alkoxy group, and the alkenyl group of L and L′, the number of carbon atoms is not greater than 5.

13. The liquid crystal display of claim 11, wherein Ar is at least one selected of:

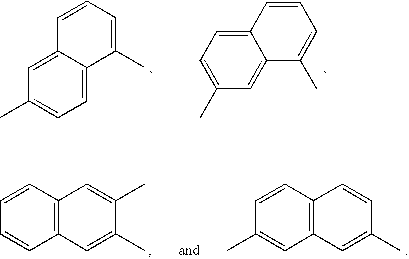

14. A liquid crystal mixture containing liquid crystals represented by Formula (1):
D-C-A-C′-D′ (1)
wherein A is a phenyl compound, a biphenyl compound, a terphenyl compound, or a naphthalene compound; C and C′ are each independently at least one of —COO—, —OOC—, —CF₂O—, and —OF₂C—; D and D′ are each independently at least one of a compound represented by Formula (2) and a compound represented by Formula (3): 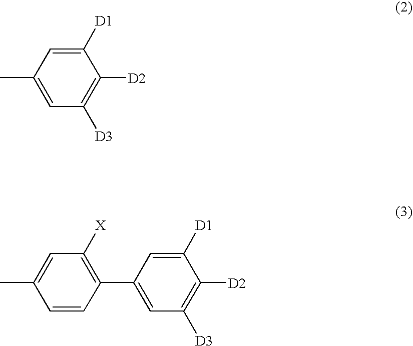
wherein D1 and D3 are each independently at least one of H, F, and Cl; D2 is at least one of H, F, Cl, —OCF3, an alkyl group having 5 or less carbons, an alkoxy group having 5 or less carbons, and an alkenyl group having 5 or less carbons; and X is at least one of H, F, and Cl.

15. The liquid crystal mixture of claim 14, wherein in the liquid crystal mixture represented by Formula (1), A is at least one of 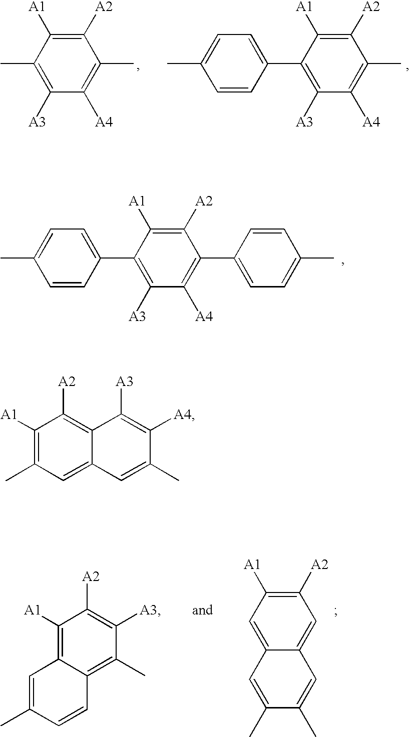
wherein A1, A2, A3, and A4 are each independently at least one of H, F, and Cl.

16. The liquid crystal mixture of claim 14, wherein C and C′ are each independently at least one of—CF₂O— and —OF₂C—.

17. The liquid crystal mixture of claim 14, wherein B is further included between C and A, or B′ is further included between A and C′, in the liquid crystal mixture represented by Formula (1).

18. The liquid crystal mixture of claim 17, wherein B and B′ are each independently at least one of phenyl, phenyl-cyclohexane, and cyclohexane-phenyl.
